(19) United States
(12) Patent Application Publication
(10) Pub. No.: US 2026/0180629 A1
(43) Pub. Date: Jun. 25, 2026

(54) DETERMINING MULTI-AOA MULTI-RX COVERAGE

(71) Applicant: Lenovo (Singapore) Pte. Ltd., Singapore (SG)

(72) Inventor: Colin Frank, Park Ridge, IL (US)

(21) Appl. No.: 19/127,038

(22) PCT Filed: Nov. 6, 2023
(86) PCT No.: PCT/IB2023/061198

§ 371 Date: May 2, 2025

Related U.S. Application Data
(60) Provisional application No. 63/422,921, filed on Nov. 4, 2022.

(51) Int. Cl. H04B 7/0413; H01Q 1/24; H04L 5/00

(52) U.S. Cl. CPC H04B 7/0413; H01Q 1/243; H04L 5/0048

(57) ABSTRACT

Various aspects of the present disclosure relate to coverage evaluation of multiple Angle-of-Arrival (multi-AoA) and simultaneous reception. A testing apparatus may be configured to transmit a first plurality of signals and receive, from a UE, a first plurality of measurement values, including a set of antenna module identifiers for which one or more of the first plurality of signals are successfully demodulated. The testing apparatus may be configured to determine a set of antenna tuples for multi-layer reception based on the first plurality of measurement values and transmit a second plurality of signals based on the set of antenna tuples. The testing apparatus may be configured to receive a second plurality of measurement values and determine a spherical coverage of the UE for simultaneous reception.

### TECHNICAL FIELD

The present disclosure relates to wireless communications, and more specifically to schemes for complexity reduction methods for the coverage evaluation of multiple Angle-of-Arrival (multi-AoA) and simultaneous reception.

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a test equipment (TE) comprising a means for transmitting a first plurality of signals and receiving, from a UE, a first plurality of measurement values comprising a set of antenna module identifiers (IDs) for which one or more of the first plurality of signals are successfully demodulated. The TE described herein may further comprise a means for determining a set of antenna tuples for multi-layer reception based on the first plurality of measurement values and transmitting a second plurality of signals based on the set of antenna tuples. The TE described herein may further comprise a means for receiving a second plurality of measurement values and determining a spherical coverage of the UE for simultaneous reception.

Some implementations of the method and apparatuses described herein may include a UE comprising a means for identifying a set of antenna modules corresponding to a receiver of the UE and receiving a first plurality of signals. The UE described herein may further comprise a means for reporting a first plurality of measurement values based on the first plurality of signals, wherein the first plurality of measurement values include a set of antenna module IDs for which one or more of the first plurality of signals are successfully demodulated. The UE described herein may further comprise a means for receiving a second plurality of signals using a plurality of pairs of antenna modules and reporting a second plurality of measurement values based on the second plurality of signals.

### BRIEF DESCRIPTION OF THE DRAWINGS

FIG. 1 illustrates an example of a wireless communication system in accordance with aspects of the present disclosure.

FIG. 2 illustrates an example of a wireless communications system for multi-antenna panel transmission and reception, in accordance with aspects of the present disclosure.

FIG. 3 illustrates an example of a communication device (e.g., UE) with multiple antenna panels, in accordance with aspects of the present disclosure.

FIG. 4 illustrates an example of a spherical coordinate system associated with testing a communication device, in accordance with aspects of the present disclosure.

FIG. 5 illustrates an example of a system for determining spherical coverage of a communication device, in accordance with aspects of the present disclosure.

FIG. 6 illustrates an example of a user equipment (UE) 600, in accordance with aspects of the present disclosure.

FIG. 7 illustrates an example of a processor 700, in accordance with aspects of the present disclosure.

FIG. 8 illustrates an example of a network equipment (NE) 800, in accordance with aspects of the present disclosure.

FIG. 9 illustrates a flowchart of a first method performed by a test equipment (TE), in accordance with aspects of the present disclosure.

FIG. 10 illustrates a flowchart of a second method performed by a UE, in accordance with aspects of the present disclosure.

### DETAILED DESCRIPTION

Generally, the present disclosure describes systems, methods, and apparatuses for enhanced Angle-of-Arrival (AoA) and Effective Isotropic Sensitivity (EIS) measurements and complexity reduction of determining the spherical coverage with simultaneous reception of independent signals from at least two different AoA values. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

Spherical coverage refers to a range of angles (i.e., in a three-dimensional space) on which a radio receiver (e.g., of a UE) can receive (and decode) radio frequency (RF) signals, e.g., that satisfy a threshold power level. Due to its mobile nature, the UE is expected to receive signals over a wide range of directions relative to the UE body. Because of the randomness of mobile wireless channels, the antenna systems in a UE should have a large spherical coverage. To improve spherical coverage, a UE typically has multiple antenna modules.

The present disclosure describes aspects of determining a spherical coverage of the UE for simultaneous reception. In particular, the present disclosure describes solutions for reducing the complexity of spherical coverage evaluation for the multi-AoA and multi-Rx scenario by enhanced reporting by the UE to enable a reduction in the number of the number of required measurements for spherical coverage evaluation.

Implementations of multi-antenna panel transmission and reception are described, such as related to reducing complexity of spherical coverage evaluation for simultaneous reception of multiple independent signals arriving from different directions/angles. By utilizing the described techniques, aspects of the operability and coverage requirements for a communication device are defined.

The described techniques facilitate a reduction in testing time, particularly when evaluating a communication device (e.g., a UE) for multi-panel transmission and/or multi-panel reception with multiple TRPs, which can be time-consuming, labor intensive, complex, and expensive to perform. For example, rather than using two test probes simultaneously to measure all of the different simultaneous transmission and/or simultaneous reception pairs of directions around a device, a two-part procedure may be implemented that uses single probe testing to capture AoA and EIS data of the communication device's antenna modules. The test equipment uses the single-probe data to reduce the number of antenna panel/module and AoA combinations needed for the evaluation of spherical coverage evaluation for simultaneous reception of multiple independent signals arriving from different directions/angles. The ability of the UE to receive simultaneously can then be validated by simultaneous reception with a fewer combinations of azimuth/elevation pairs for the two TRPs (e.g., probes) which are controlled by the test equipment.

A communication device, such as a UE, operating in frequency range #2 (FR2) has a spherical coverage requirement, which is a lower bound on the cumulative distribution function of the Equivalent Isotropic Radiated Power (EIRP) measured over a sphere. Specifically, the requirement is a lower bound on the EIRP that must be achieved at a specified percentile of the cumulative distribution function. The percentile that is specified depends on the power class and the corresponding device type, where the device type reflects both the form factor and the intended use of the device. Similar peak and spherical coverage requirements are defined for the EIS.

However, the peak EIS is defined as an upper bound on the minimum value of the EIS in the receive beam peak direction and the coverage requirement is defined in terms of an upper bound on the EIS that must be achieved at a specified percentile of the complementary cumulative distribution function. Similar to the EIRP, the EIS requirements are a function of the power class and the frequency band.

Multi-panel reception can be used for a combination of increased range and/or throughput using improved receiver sensitivity, multi-input multi-output (MIMO) reception, and carrier aggregation. Similarly, multi-panel transmission can be used for a combination of increased range and/or throughput using increased transmit power, MIMO transmission, and carrier aggregation. Typically, each antenna panel (also referred to as an antenna module) in a communication device (e.g., a UE) has one set of power amplifiers for each antenna panel, where the number of power amplifiers is equal to the number of antenna elements in the antenna panel. Thus, if two panels are used to transmit simultaneously, the transmission power can be increased.

Similarly, if two panels are used to receive simultaneously, the receiver sensitivity is improved because the receiver noise from the two panels is independent. In some cases, multi-panel transmission and reception may take place with the same transmission-reception point (TRP) while in other cases, the multi-panel transmission and reception may take place with multiple TRPs that are not co-located.

Aspects of the present disclosure are described in the context of a wireless communications system. Aspects of the present disclosure are further illustrated and described with reference to device diagrams and flowcharts that relate to multi-antenna panel transmission and reception.

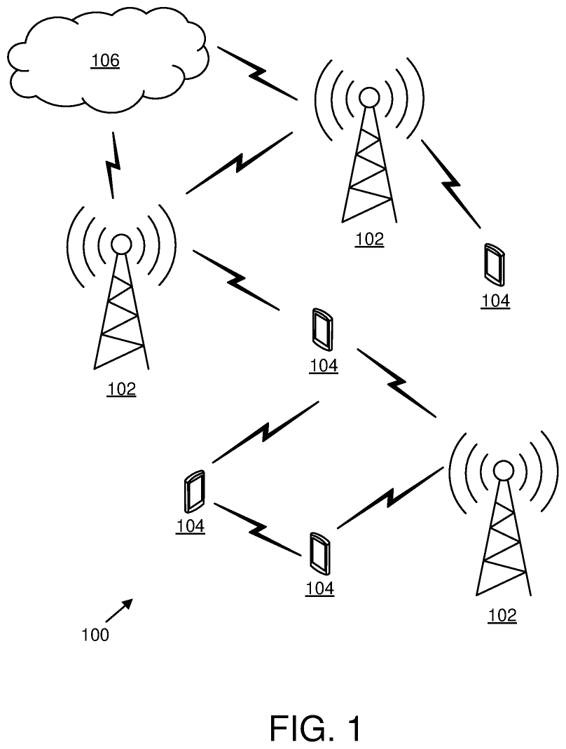

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

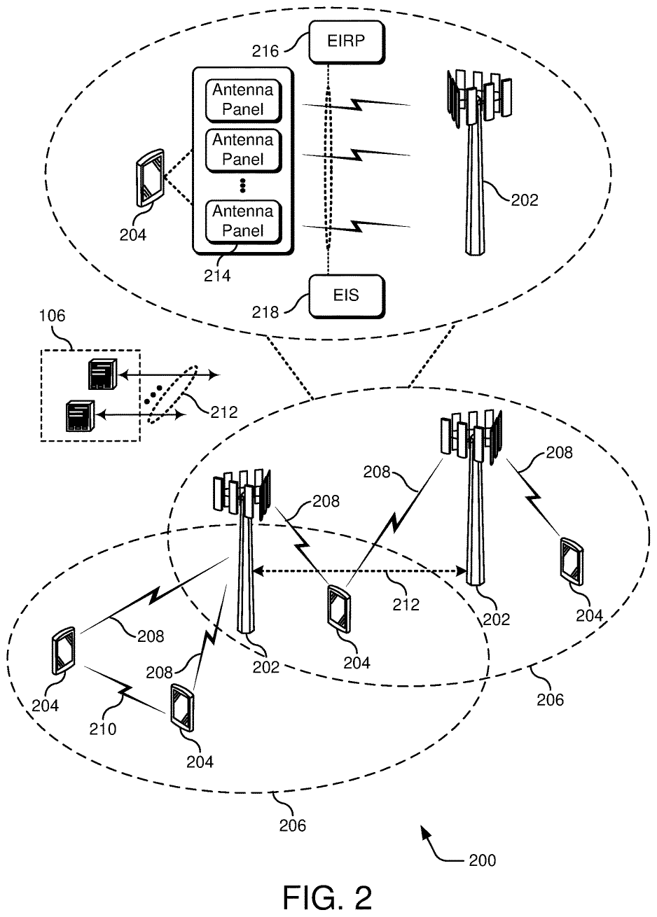

FIG. 2 illustrates one embodiment of a wireless communications system 200 that supports multi-antenna panel transmission and reception. The wireless communications system 200 may be one embodiment of the system 100 and may include one or more base station units 202, one or more UEs 204, and a CN 106. The wireless communications system 200 may support various radio access technologies. In some implementations, the wireless communications system 200 may be a 4G network, such as an LTE network or an LTE-A network. In some other implementations, the wireless communications system 200 may be a 5G network, such as a NR network. In other implementations, the wireless communications system 200 may be a combination of a 4G network and a 5G network. The wireless communications system 200 may support radio access technologies beyond 5G. Additionally, the wireless communications system 200 may support technologies, such as TDMA, FDMA, or CDMA, etc.

A base station unit 202 may be one embodiment of the NE 102 and may provide a geographic coverage area 206 for which the base station unit 202 may support services (e.g., voice, video, packet data, messaging, broadcast, etc.) for one or more UEs 204 within the geographic coverage area. One or more base station units 202 may for a RAN with which the one or more UEs 204 communicates using wireless communication links 208. The UEs 204 may communicate directly with one or more of the base station units 202 via uplink (UL) and/or downlink (DL) communication signals carried over the wireless communication links 208. Furthermore, the UL communication signals may comprise one or more uplink channels, such as the Physical Uplink Control Channel (PUCCH) and/or Physical Uplink Shared Channel (PUSCH), while the DL communication signals may comprise one or more DL channels, such as the Physical Broadcast Channel (PBCH), Physical Downlink Control Channel (PDCCH) and/or Physical Downlink Shared Channel (PDSCH).

The one or more UEs 204 may be dispersed throughout a geographic region or geographic coverage area 206 of the wireless communications system 200. Additionally, or alternatively, a UE 204 may be referred to as an Internet-of-Things (IoT) device, an Internet-of-Everything (IoE) device, or as a machine-type communication (MTC) device, among other examples. In some implementations, a UE 204 may be stationary in the wireless communications system 200. In other implementations, a UE 204 may be mobile in the wireless communications system 200, such as an earth station in motion (ESIM).

The one or more UEs 204 may be devices in different forms or having different capabilities. Some examples of UEs 204 are illustrated in FIG. 2. A UE 204 may be capable of communicating with various types of devices, such as the base station units 202, other UEs 204, or network equipment (e.g., the CN 106, a relay device, a gateway device, an integrated access and backhaul (IAB) node, a location server that implements the location management function (LMF), or other network equipment). Additionally, or alternatively, a UE 204 may support communication with other base station units 202 or UEs 204, which may act as relays in the wireless communications system 200.

A UE 204 may also support wireless communication directly with other UEs 204 over a sidelink communication link 210. For example, a UE 204 may support wireless communication directly with another UE 204 over a device-to-device (“D2D”) communication link. In some implementations, such as vehicle-to-vehicle (“V2V”) deployments, vehicle-to-everything (“V2X”) deployments, or cellular-V2X deployments, the communication link 210 may be referred to as a sidelink. For example, a UE 204 may support wireless communication directly with another UE 204 over a PC5 interface.

A base station unit 202 may support communications with the CN 106, or with another base station unit 202, or both. For example, a base station unit 202 may interface with the CN 106 through one or more backhaul links 212 (e.g., via an S1, N2, or another network interface). The base station units 202 may communicate with each other over the backhaul links 212 (e.g., via an X2, Xn, or another network interface). In some implementations, the base station units 202 may communicate with each other directly (e.g., between the base station units 202). In some other implementations, the base station units 202 may communicate with each other indirectly (e.g., via the CN 106). In some implementations, one or more base station units 202 may include subcomponents, such as an access network entity, which may be an example of an access node controller (ANC). The ANC may communicate with the one or more UEs 204 through one or more other access network transmission entities, which may be referred to as remote radio heads, smart radio heads, gateways, transmission-reception points (TRPs), and other network nodes and/or entities.

According to implementations, a UE 204 is operable to implement various aspects of multi-antenna panel transmission and reception, as described herein. For instance, a UE 204 includes a transceiver and a set of antenna panels 214 that are each configured to transmit and/or receive signals from a TRP (e.g., a base station unit 202). Notably, the wireless communications system 200 can include any number of TRPs. The UE 204 can include a processor and/or communications manager (e.g., any one or more combination of components) configured to cause the UE to transmit and/or receive one or more signals with respect to one or more TRPs.

The power classes and the corresponding UE types are provided as UE power class (1) for a fixed wireless access (FWA) UE; UE power class (2) for a vehicular UE; UE power class (3) for a handheld UE; UE power class (4) for a high-power non-handheld UE; and UE power class (5) for a FWA UE.

For FWA UEs (UE power classes 1 and 5), it can be assumed that the device is installed so that an antenna panel 214 is oriented to point in the general direction of the base station unit 202 (e.g., a gNB). As a result, the gain of this antenna panel 214 in the direction of the base station unit 202 will not be much less than the peak gain of the panel. For this reason, the base station unit 202 coverage requirement is set at 85% of the cumulative distribution function of the Equivalent Isotropic Radiated Power (EIRP) 216. Note that EIRP is the measure of power in a specific direction, including the transmitted power, the transmission loss in the RF chain, implementation loss, the array gain and so on.

For the vehicular UE (power class 2), the orientation of the antenna panels relative to the vehicle can be controlled by the car manufacturer, but the orientation of the vehicle relative to the base station unit 202 is unknown. As a result, the coverage requirement is specified at 60% of the cumulative distribution function of the EIRP 216.

For the handheld UE (power class 3), the orientation of the device relative to the base station unit 202 is unknown and as a result the coverage requirement is set at 50% of the cumulative distribution of the EIRP 216. Finally, for the high-power non-handheld UE (power class 4), a high level of reliability is required, and therefore the coverage requirement is specified at 20% of the cumulative distribution function of the EIRP 216.

Similar peak and spherical coverage requirements are defined for the EIS 218. However, the peak EIS 218 is defined as a limit on the minimum value of the EIS 218 in the receive beam peak direction and the coverage requirement is defined in terms of the complementary cumulative distribution function. Similar to the EIRP 216, the EIS 218 requirements are a function of the power class and the frequency band. For the spherical coverage requirements, the percentile values are the same as for the EIRP 216—that is, the percentile requirements are 85%, 60%, 50%, 20%, and 85% for the respective power classes 1, 2, 3, 4, and 5 (as described above).

The EIRP spherical coverage requirements for the different power classes are shown in the tables T1-T5 below:

TABLE T1
UE Spherical Coverage for Power Class 1

| Operating band | Min EIRP at 85%-tile CDF (dBm) |
|---|---|
| n257 | 32.0 |
| n258 | 32.0 |
| n260 | 30.0 |
| n261 | 32.0 |
| n262 | 26.0 |

NOTE 1:
Minimum EIRP at 85%-tile CDF is defined as the lower limit without tolerance
NOTE 2:
The requirements in this table are verified only under normal temperature conditions as defined in Annex E.2.1.

TABLE T2
UE Spherical Coverage for Power Class 2

| Operating band | Min EIRP at 60%-tile CDF (dBm) |
|---|---|
| n257 | 18.0 |
| n258 | 18.0 |
| n261 | 18.0 |
| n262 | 11.0 |

NOTE 1:
Minimum EIRP at 60%-tile CDF is defined as the lower limit without tolerance
NOTE 2:
The requirements in this table are verified only under normal temperature conditions as defined in Annex E.2.1.

TABLE T3
UE Spherical Coverage for Power Class 3

| Operating band | Min EIRP at 50%-tile CDF (dBm) |
|---|---|
| n257 | 11.5 |
| n258 | 11.5 |
| n259 | 5.8 |
| n260 | 8 |
| n261 | 11.5 |
| n262 | 2.9 |

NOTE 1:
Minimum EIRP at 50%-tile CDF is defined as the lower limit without tolerance
NOTE 2:
The requirements in this table are verified only under normal temperature conditions as defined in Annex E.2.1.

TABLE T4
UE Spherical Coverage for Power Class 4

| Operating band | Min EIRP at 20%-tile CDF (dBm) |
|---|---|
| n257 | 25 |
| n258 | 25 |
| n260 | 19 |
| n261 | 25 |
| n262 | 16.2 |

NOTE 1:
Minimum EIRP at 20%-tile CDF is defined as the lower limit without tolerance
NOTE 2:
The requirements in this table are verified only under normal temperature conditions as defined in Annex E.2.1.

TABLE T5
UE Spherical Coverage for Power Class 5

| Operating band | Min EIRP at 85%-tile CDF (dBm) |
|---|---|
| n257 | 22 |
| n258 | 22.4 |
| n259 | 19.7 |

NOTE 1:
Minimum EIRP at 85%-tile CDF is defined as the lower limit without tolerance
NOTE 2:
The requirements in this table are verified only under normal temperature conditions as defined in Annex E.2.1.

The EIS spherical coverage requirements for the different power classes are shown in the tables T6-T10 below:

TABLE T6
EIS Spherical Coverage for Power Class 1

| | EIS at 85^{th} %-tile CCDF (dBm)/Channel bandwidth | | | |
|---|---|---|---|---|
| Operating band | 50 MHz | 100 MHz | 200 MHz | 400 MHz |
| n257 | −89.5 | −86.5 | −83.5 | −80.5 |
| n258 | −89.5 | −86.5 | −83.5 | −80.5 |
| n260 | −86.5 | −83.5 | −80.5 | −77.5 |
| n261 | −89.5 | −86.5 | −83.5 | −80.5 |
| n262 | −84.3 | −81.3 | −78.3 | −75.3 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

TABLE T7
EIS Spherical Coverage for Power Class 2

| | EIS at 60^{th} %-tile CCDF (dBm)/Channel bandwidth | | | |
|---|---|---|---|---|
| Operating band | 50 MHz | 100 MHz | 200 MHz | 400 MHz |
| n257 | −81.0 | −78.0 | −75.0 | −72.0 |
| n258 | −81.0 | −78.0 | −75.0 | −72.0 |
| n261 | −81.0 | −78.0 | −75.0 | −72.0 |
| n262 | −74.9 | −71.9 | −68.9 | −65.9 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

TABLE T8
EIS Spherical Coverage for Power Class 3

| | EIS at 50^{th} %-tile CCDF (dBm)/Channel bandwidth | | | |
|---|---|---|---|---|
| Operating band | 50 MHz | 100 MHz | 200 MHz | 400 MHz |
| n257 | −77.4 | −74.4 | −71.4 | −68.4 |
| n258 | −77.4 | −74.4 | −71.4 | −68.4 |
| n259 | −71.9 | −68.9 | −65.9 | −62.9 |
| n260 | −73.1 | −70.1 | −67.1 | −64.1 |
| n261 | −77.4 | −74.4 | −71.4 | −68.4 |
| n262 | −69.7 | −66.7 | −63.7 | −60.7 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

TABLE T9
EIS Spherical Coverage for Power Class 4

| | EIS at 20^{th} %-tile CCDF (dBm)/Channel bandwidth | | | |
|---|---|---|---|---|
| Operating band | 50 MHz | 100 MHz | 200 MHz | 400 MHz |
| n257 | −88.0 | −85.0 | −82.0 | −79.0 |
| n258 | −88.0 | −85.0 | −82.0 | −79.0 |
| n260 | −83.0 | −80.0 | −77.0 | −74.0 |
| n261 | −88.0 | −85.0 | −82.0 | −79.0 |
| n262 | −78.9 | −75.9 | −72.9 | −69.9 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

TABLE T10
EIS Spherical Coverage for Power Class 5

| | EIS at 85^{th} %-tile CCDF (dBm)/Channel bandwidth | | | |
|---|---|---|---|---|
| Operating band | 50 MHz | 100 MHz | 200 MHz | 400 MHz |
| n257 | −84.6 | −81.6 | −78.6 | −75.6 |
| n258 | −84.8 | −81.8 | −78.8 | −75.8 |
| n259 | −81.7 | −78.7 | −75.7 | −72.7 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

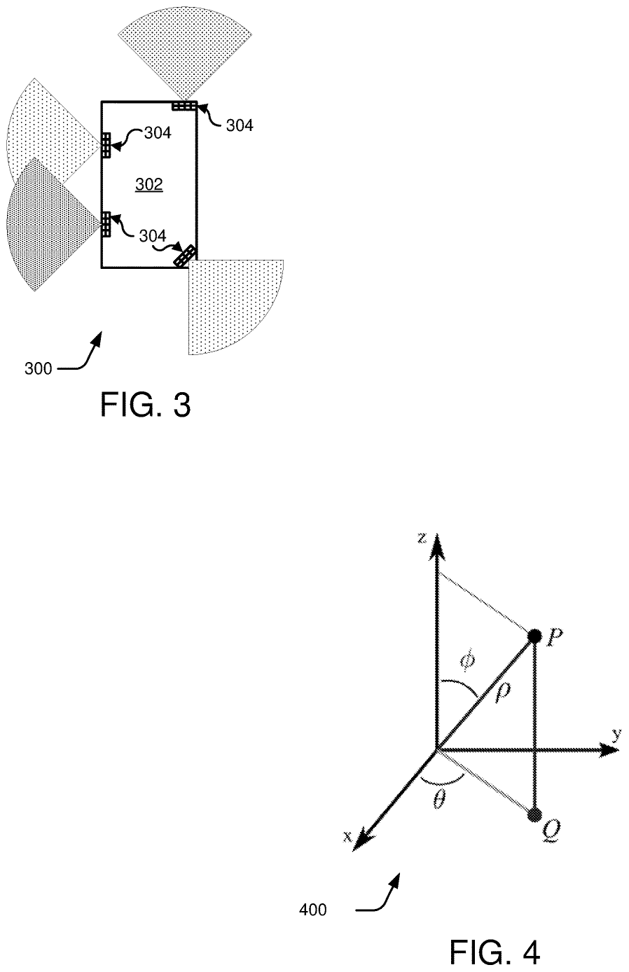

FIG. 3 illustrates an exemplary arrangement 300 of a communication device 302 with four antenna modules 304, as related to multi-antenna panel transmission and reception. The communication device 302 may be one embodiment of the UE 104 and/or the UE 204. Each antenna module 304 of the communication device 302 is comprised of multiple antenna elements which can be dipole antennas, patch antennas, or other types of antenna elements. Each antenna element can have a single polarization or dual polarizations.

In certain embodiments, the antenna elements comprising an antenna array have uniform spacing, such as half wavelength spacing. The antenna elements may be configured as a linear array, such as in a 1×8 array with eight antenna elements in a single dimension, or as a rectangular array, such as a 2×4 array with two antenna elements in a first dimension and four antenna elements in a second dimension for a total of eight antenna elements.

For handheld devices (e.g., a UE 204), it can be assumed that each communication device 302 will have at least two antenna modules 304. Certain UEs may have three or more antenna modules 304.

In order to evaluate the coverage reliability and redundancy for the communication device 302, the cumulative distribution of the second-best beam is considered for each azimuth and elevation, where the second-best beam must be from an antenna panel that is different than the antenna panel that is used to source the best beam. The cumulative distribution of the second-best beam indicates the coverage that is achievable when the best beam is either blocked or cannot be used due to Maximum Permissible Exposure (MPE) or Specific Absorption Rate (SAR) regulations. It should be noted that the panel used for the best beam and the panel used for the second-best beam will depend on the direction of measurement (azimuth and elevation) relative to the communication device 302.

A test and measurement mode of operation can be defined for a communication device 302 (e.g., the UE 104 and/or UE 204) for measurement of the EIRP with the following designated characteristics. The communication device 302 scans for the synchronization system block (SSB) or other reference signal (RS) using each of its antenna panels. Depending on the UE capability, the communication device 302 may scan for the SSB on the antenna panels sequentially or in parallel. If the communication device 302 scans for the SSB on the antenna panels sequentially, the communication device 302 scans all of the beams on the first panel prior to scanning any of the beams on the second panel. If the communication device 302 has the capability to scan for the SSB on the antenna panels simultaneously, then the communication device 302 can scan beams for each antenna panel independently. Additionally, the communication device 302 indicates to the test equipment which antenna panels have a beam that can be used to demodulate the PBCH independently of the other panels.

Further, for each antenna panel that can demodulate the PBCH, the communication device 302 transmits a known RS using the best beam from that antenna panel. The RS is transmitted at maximum power. It can be noted that separate power amplifiers are used for each antenna panel, so that the single beam from each panel can be transmitted at full power. The test equipment measures the power of the received RS to determine the EIRP for the given azimuth and elevation (relative to the communication device 302) for each antenna panel. The communication device 302 can be assigned different frequency resources (resource blocks) for each antenna panel's transmission so that the test equipment can measure the EIRP for the best beam from each antenna panel independently without the transmissions interfering with each other. If receiver blocking is a concern so that a weak signal adjacent in frequency to a strong signal may be lost due to dynamic range limitations, then the test equipment can instruct the communication device 302 to transmit on the best beams of the antenna panels sequentially using the same frequency resources.

FIG. 4 illustrates one embodiment 400 of a spherical coordinate system associated with testing a communication device (e.g., the UE 204, the UE 204, and/or the communication device 302), as related to multi-antenna panel transmission and reception. With reference to test setups, a transmit/receive test probe may be rotated in azimuth and elevation about a device that is being tested. Alternatively, the transmit/receive test probe may be fixed in position, and the device that is being tested is rotated in azimuth and elevation about the test probe. In either case, the testing integrates over the unit sphere with a radius equal to one (1).

During the EIRP test and measurement, the test equipment records the EIRP, EIRPᵢ(θⱼ, φⱼ) for each panel i, 1≤i≥N, where N is the number of antenna panels on the device, and for a set of azimuth and elevation angles (θⱼ, φⱼ), 0≤θⱼ<2π, 0≤φⱼ<π that cover the unit sphere. The measurements are taken over a set of points on a sphere centered on the device under test (e.g., the communication device 302) with sufficient granularity to achieve the required measurement accuracy and uncertainty. The measurement points are defined with respect to their azimuth and elevation relative to the communication device 302. The measurement points may be uniformly spaced or not, but the weight applied to each measurement when determining the cumulative distribution function or the complementary cumulative distribution function should reflect the area on the sphere that is closer to the measurement point than to any other measurement point as measured in steradians.

While taking the EIRP measurements as described above, the test equipment may collect one or more of the following statistics:
1) The cumulative distribution of the best beam power received from the first antenna panel;
2) The cumulative distribution of the best beam power received from the second antenna panel;
3) The cumulative distribution of the best beam power received from the n-th antenna panel;
4) The peak power received from the first antenna panel taken over all beams and all azimuths and elevations;
5) The peak power received from the second antenna panel taken over all beams and all azimuths and elevations;
6) The peak power received from the n-th antenna panel taken over all beams and all azimuths and elevations;
7) The azimuth and elevation of the peak power of the first antenna panel;
8) The azimuth and elevation of the peak power of the second antenna panel;
9) The azimuth and elevation of the peak power of the n-th antenna panel;
10) The cumulative distribution of the power received from the best beam taken over all of the UE antenna panels;
11) The cumulative distribution of the power received from the second-best beam, where the second-best beam is the best beam taken over all of the antenna panels excluding the antenna panel of the best beam;
12) The cumulative distribution of the power received from the n-th best beam, where the n-th best beam is the best beam taken over all of the antenna panels excluding the antenna panels corresponding to the best beams up to and including the n−1-st best beam; 13) The cumulative distribution of the sum of the power received from the best beam taken over all of the antenna panels and the second-best beam, where the second-best beam is the best beam taken over all antenna panels excluding the antenna panel of the best beam and the combined power is given by:

$${EIRP}_{C} ( {θ}_{j} , {ϕ}_{j} ) = {EIRP}_{1} ( {θ}_{j} , {ϕ}_{j} ) + {EIRP}_{2} ( {θ}_{j} , {ϕ}_{j} ) ;$$

14) The cumulative distribution of the sum of the power received on the best n beams where the j-th best beam is the best beam taken over all of the antenna panels excluding panels corresponding to the beams up to and including the j−1-st best beam and the combined power is given by:

$${EIRP}_{C} ( {θ}_{j} , {ϕ}_{j} ) = {EIRP}_{1} ( {θ}_{j} , {ϕ}_{j} ) + {EIRP}_{2} ( {θ}_{j} , {ϕ}_{j} ) + … + {EIRP}_{n} ( {θ}_{j} , {ϕ}_{j} ) .$$

A test and measurement mode of operation can be defined for a communication device (e.g., a UE) for determining the EIS with the following designated characteristics. The UE scans for the SSB or other RS using each of its antenna panels. Depending on the UE capability, the UE may scan for the SSB on the antenna panels sequentially or in parallel. If the UE scans for the SSB on the antenna panels sequentially, the UE scans all of the beams on the first panel prior to scanning any of the beams on the second panel. If the UE has the capability to scan for the SSB on the antenna panels simultaneously, then the UE can scan beams for each antenna panel independently. Additionally, the UE indicates to the test equipment which antenna panels have a beam that can be used to demodulate the PBCH independently of the other panels. The test equipment transmits a RS to the UE at a first power level.

Using the best beam at each antenna panel, the UE attempts to demodulate the RS. The beams are not combined prior to demodulation. Depending on the UE capability, the UE may demodulate the R on the best beams of the UE antenna panels sequentially or in parallel. The UE determines the error rate for the demodulated test signal. Further, the UE indicates for each antenna panel whether or not the error rate exceeded the threshold defined for reference sensitivity. If the error rate was not exceeded for at least one antenna panel, the test equipment transmits the RS to the UE at a power level that is less than the first power level. The reference sensitivity for each antenna panel is the minimum power for which the RS is demodulated with an error rate less than the threshold defined for reference sensitivity. Alternatively, the test equipment could start at a very low power level and increase the power until the UE is able to demodulate the signal with less than the required error rate.

During the EIS test and measurement, the test equipment records the EIS, EISᵢ(θⱼ, φⱼ) for each panel i, 1≤i≤P, where P is the number of antenna panels on the device, and for a set of azimuth and elevation angles (θⱼ, φⱼ), 0≤θⱼ<2π, 0≤φⱼ<π that cover the unit sphere. The measurements are taken over a set of points on a sphere centered on the device under test (e.g., the UE) with sufficient granularity to achieve the required measurement accuracy and uncertainty. The measurement points are defined with respect to their azimuth and elevation relative to the UE. The measurement points may be uniformly spaced or not, but the weight applied to each measurement when determining the cumulative distribution function or the complementary cumulative distribution function should reflect the area on the sphere that is closer to the measurement point than to any other measurement point.

While taking the EIS measurements as described above, the test equipment collects the following statistics:
1) The complementary cumulative distribution of the best beam EIS for the first antenna panel;
2) The complementary cumulative distribution of the best beam EIS for the second antenna panel;
3) The complementary cumulative distribution of the best beam EIS for the n-th antenna panel;
4) The minimum EIS for the first antenna panel taken over all beams and all azimuths and elevations;
5) The minimum EIS for the second antenna panel taken over all azimuths and elevations;
6) The minimum EIS for the n-th antenna panel taken over all azimuths and elevation;
7) The azimuth and elevation of the minimum EIS of the first antenna panel;
8) The azimuth and elevation of the minimum EIS of the second antenna panel;
9) The azimuth and elevation of the minimum EIS of the n-th antenna panel;
10) The complementary cumulative distribution of best beam EIS taken over all of the antenna panels;
11) The complementary cumulative distribution of the EIS of the second-best beam where the second-best beam is the best beam taken over all of the antenna panels excluding the antenna panel of the best beam;
12) The complementary cumulative distribution of the EIS of the n-th best beam where the n-th best beam is the best beam taken over all of the antenna panels excluding the antenna panels corresponding to the best beams up to and including the n−1-st best beam;
13) The cumulative distribution of the combined EIS of the best beam taken over all of the antenna panels and the second-best beam where the second-best beam is the best beam taken over all of the antenna panels excluding the panels corresponding to the best beam, where the combined EIS is given by:

$${EIS}_{C} ( {θ}_{j} , {ϕ}_{j} ) = {( \frac{1}{{EIS}_{1} ( {θ}_{j} , {ϕ}_{j} )} + \frac{1}{{EIS}_{2} ( {θ}_{j} , {ϕ}_{j} )} )}^{- 1} ;$$

and
14) The cumulative distribution of the combined EIS of the n best beams taken over all of the antenna panels, where the j-th best beam is the best beam taken over all of the antenna panels excluding panels corresponding to the beams up to and including the j−1-st best beam, and where the combined EIS is given by:

$${EIS}_{C} ( {θ}_{j} , {ϕ}_{j} ) = {( \frac{1}{{EIS}_{1} ( {θ}_{j} , {ϕ}_{j} )} + \frac{1}{{EIS}_{2} ( {θ}_{j} , {ϕ}_{j} )} + … + \frac{1}{{EIS}_{n} ( {θ}_{j} , {ϕ}_{j} )} )}^{- 1} .$$

In order to address reducing the typical measurement time required to take the EIRP and EIS measurements for a communication device (e.g., a UE) that has multiple antenna panels, innovative test modes are described in this disclosure. For the EIRP measurement, after determining the best beam for each panel for a given azimuth and elevation from reception of the SSB, the UE transmits a RS with maximum power on the best beam for each antenna panel. The UE can be assigned different frequency resources (resource blocks) for each antenna panel's transmission so that the test equipment can measure the EIRP for the best beam from each antenna panel independently without the transmissions interfering with each other. For the EIS measurement, after determining the best beam for each panel for a given azimuth and elevation using the received SSB, the UE receives a RS from the test equipment and demodulates the RS independently for each antenna panel using the best beam. The UE indicates for each power level and each antenna panel whether or not the error rate exceeded the threshold defined for reference sensitivity.

When defining coverage requirements with multi-panel transmission and reception, there are primarily two cases that are taken into consideration. Notably, multi-panel requirements for a single TRP, and multi-panel requirements for two or more TRPs. In the case of the multi-panel requirements for two or more TRPs, each antenna panel transmits to and receives from a single transmission point, which is different from the TRPs from which the other antenna panels transmit and receive. Coverage requirements are considered for each of these two cases.

With respect to multi-panel, single-TRP coverage requirements, the combined EIRP, EIRP_{C}(θ, φ), and the combined EIS, EIS_{C}(θ, φ), described above in the respective steps 13 for the EIRP and EIS measurements, reflect the combined EIRP and EIS when a communication device (e.g., a UE) is using the two best panels to transmit to and receive from a single TRP. It should be noted that the two best panels will depend on the direction (θ, φ) of the TRP relative to the UE.

It should be noted that one or more embodiments described herein may be combined into a single embodiment.

In certain embodiments, such as for NR FR2 multi-Rx chain, DL reception may have the following objectives: 1) have requirements for enhanced FR2 UEs with simultaneous DL reception with two different quasi-co-location (QCL) Type-D RSs on single component carrier with up to four (4) layer DL MIMO; 2) have enhanced RF requirements: specify RF requirements, mainly spherical coverage requirements, for devices with simultaneous reception from different directions with different QCL Type-D RSs.

In some embodiments, it may be determined how to define spherical coverage requirements with simultaneous reception from different directions. Additionally, given the difficulty of placing two probes at all pairs of directions relative to the UE as well as the time required to take measurements over a sufficiently large number of direction pairs to accurately determine coverage, it may be possible to estimate multi-Rx spherical coverage using a single measurement probe. Multiple probes may then be used to verify the ability of the UE to receive simultaneously over a small number of direction pairs within the coverage region.

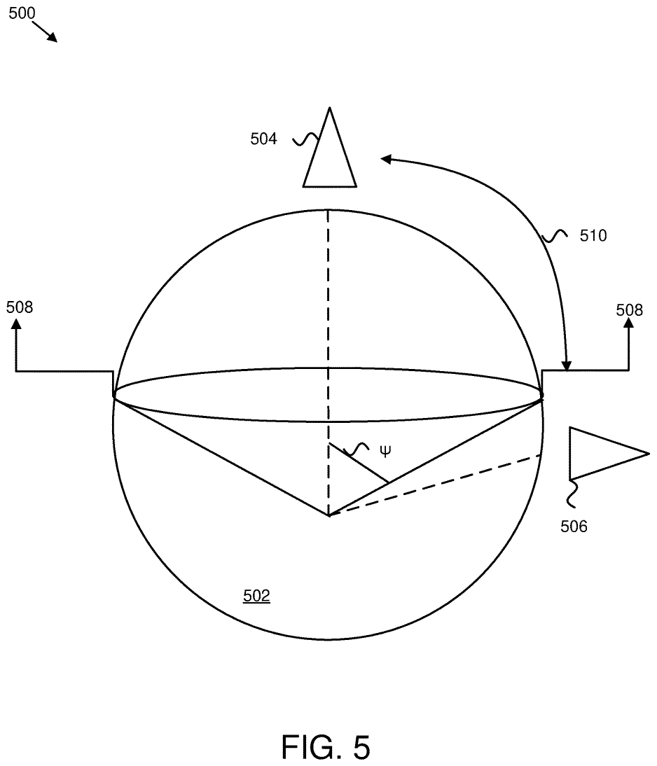

FIG. 5 is a schematic diagram illustrating one embodiment of a system 500 corresponding to embodiments described herein. FIG. 5 illustrates a region E(ψ, (φ₁, θ₁)) from which the second TRP is excluded when determining conditional spherical coverage for a minimum separation angle ψ. The system 500 includes a UE showing a sphere 502 reception area around the UE. Moreover, the system includes a TRP 1 (φ₁, θ₁) 404 and a TRP 2 (φ₂, θ₂) 506. A portion 508 of the sphere 502 is an exclusion zone, and a distance 510 where Ω≥ψ is between the first TRP 504 (denoted “TRP 1”) and the second TRP 506 (denoted “TRP 2”). Moreover, E(ψ, (φ, θ)) denotes the exclusion zone of angle ψ around the direction (φ, θ). The area of this exclusion zone on the unit sphere (e.g., measured in steradians) is given by:

$$2 π ( 1 - cos ψ ) ,$$

for which the corresponding fraction of the sphere 502 that is excluded is given by:

$$\frac{2 π ( 1 - cos ψ )}{4 π} = \frac{1 - cos ψ}{2} .$$

Let Ē(ψ, (φ, θ)) denote the complement of the exclusion zone, and note that the fraction of the sphere 502 which is not excluded is given by:

$$\frac{4 π - 2 π ( 1 - cos ψ )}{4 π} = \frac{1 + cos ψ}{2}$$

In certain embodiments, an EIS spherical coverage requirement may be defined when receiving from multiple directions simultaneously. Given the extreme difficulty of measuring the cumulative distribution of the EIS when receiving from multiple directions simultaneously, effective techniques for reducing the complexity of the evaluation can save cost and time.

Before the spherical coverage can be defined, it is first necessary to consider the figure of merit for simultaneous reception from two different angles of arrival. The following possibilities can be considered.

Regarding the case of a single MIMO layer, consider the EIS when a single layer is transmitted from two TRP's with two AOA's (one EIS value).

Regarding the case of two MIMO layers, consider both the per-layer EIS and the sum of the per-layer EIS. The per-layer EIS when one layer is transmitted from a first TRP at AOA1 and a second layer is transmitted from a second TRP at AOA2 (two EIS values). The sum of the per-layer EIS for AOA1 and AOA2 when one layer is transmitted from a first TRP at AOA1 and a second layer is transmitted from a second TRP at AOA2 (one EIS value).

For the case of four MIMO layers, consider both the sum EIS for first and second layers and the sum of the sum EIS for first and second layers. The sum EIS for first and second layers transmitted from a first TRP at AOA1 and the sum EIS for third and fourth layers transmitted from a second TRP at AOA2 (two EIS values). The sum of the sum EIS for first and second layers transmitted from a first TRP at AOA1 and the sum EIS for third and fourth layers transmitted from a second TRP at AOA2 (one EIS value).

Regardless of the number of layers and the figure of merit that is chosen, coverage can be defined in terms of a complementary cumulative distribution function as defined in Third Generation Partnership Project (3GPP) Technical Document (TDoc) R4-2216875, “On Defining Coverage Requirements for Multi-Rx Chain Downlink Reception”, Lenovo, 3GPP TSG-RAN WG4 Meeting RAN4 #104-bis-e, which document is hereby incorporated by reference. When receiving a single layer from two directions simultaneously, let

$${EIS}_{S}^{1 L} ( ( {ϕ}_{1} , {θ}_{1} ) , ( {ϕ}_{2} , {θ}_{2} ) )$$

denote the combined EIS from a first TRP at (φ₁, θ₁) and a second TRP at (φ₂, θ₂) required to achieve the Refsens error rate for the reference measurement channel, and let the set

$${A}_{S}^{1 L}$$

(α) be defined as

$${A}_{S}^{1 L} ( α ) = ( ( {ϕ}_{1} , {θ}_{1} ) , ( {ϕ}_{2} , {θ}_{2} ) : {EIS}_{S}^{1 L} ( ( {ϕ}_{1} , {θ}_{1} ) , ( {ϕ}_{2} , {θ}_{2} ) ) \leq α ) .$$

As discussed in 3GPP TDoc R4-2216875, if the angles of arrival AOA1 and AOA2 are randomly selected over the unit sphere, the complementary cumulative distribution function of the combined EIS can be expressed as

$${CCDF}_{S}^{1 L} ( α ) = 1 - \frac{1}{16 {π}^{2}} {\sum }_{i = 1}^{N} {\sum }_{j = 1}^{N} {I}_{{A}_{S}^{1 L} ( α )} ( {ϕ}_{i} , {θ}_{i} , {ϕ}_{j} , {θ}_{j} ) W ( {ϕ}_{i} , {θ}_{i} ) W ( {ϕ}_{j} , {θ}_{j} )$$

where

$${I}_{{A}_{S}^{1 L} ( α )}$$

(φᵢ, θᵢ, φⱼ, θⱼ) is the indicator function given by

$${I}_{{A}_{S}^{1 L} ( α )} ( {ϕ}_{i} , {θ}_{i} , {ϕ}_{j} , {θ}_{j} ) = \{ \begin{matrix}1 & ( {ϕ}_{i} , {θ}_{i} , {ϕ}_{j} , {θ}_{j} ) ∈ {A}_{S}^{1 L} ( α ) \\ 0 & else\end{matrix}$$

and W(φᵢ, θᵢ) reflects the area of the unit sphere corresponding to (φᵢ, θᵢ) with the property that

$${\sum }_{i = 1}^{N} W ( {ϕ}_{i} , {θ}_{i} ) = 4 π .$$

If the angles AOA1 and AOA2 are not allowed to be the same, then the expression

$${CCDF}_{S}^{1 L}$$

(α) can be simplified as

$${CCDF}_{S}^{1 L} ( α ) = 1 - \frac{1}{8 {π}^{2}} {\sum }_{i = 2}^{N} {\sum }_{j = 1}^{i - 1} {I}_{{A}_{S}^{1 L} ( α )} ( {ϕ}_{i} , {θ}_{i} , {ϕ}_{j} , {θ}_{j} ) W ( {ϕ}_{i} , {θ}_{i} ) W ( {ϕ}_{j} , {θ}_{j} ) \qquad Eq . ( 1 )$$

based on the fact that

$${EIS}_{S}^{1 L} ( ( {ϕ}_{1} , {θ}_{1} ) , ( {ϕ}_{2} , {θ}_{2} ) ) = {EIS}_{S}^{1 L} ( ( {ϕ}_{2} , {θ}_{2} ) , ( {ϕ}_{1} , {θ}_{1} ) ) .$$

If the angles AOA1 and AOA2 are allowed to be the same, then CCDF_{S}(α) can be simplified as

$${CCDF}_{S}^{1 L} ( α ) = 1 - ( \frac{1}{8 {π}^{2}} {\sum }_{i = 2}^{N} {\sum }_{j = 1}^{i - 1} {I}_{{A}_{S}^{1 L} ( α )} ( {ϕ}_{i} , {θ}_{i} , {ϕ}_{j} , {θ}_{j} ) W ( {ϕ}_{i} , {θ}_{i} ) W ( {ϕ}_{j} , {θ}_{j} ) + \frac{1}{16 {π}^{2}} {\sum }_{i = 1}^{N} {I}_{{A}_{S}^{1 L} ( α )} ( {ϕ}_{i} , {θ}_{i} , {ϕ}_{i} , {θ}_{i} ) {( W ( {ϕ}_{i} , {θ}_{i} ) )}^{2} ) \qquad Equation ( 2 )$$

The number of measurements needed for Equation (1) is N²−N/2 and the number of measurements needed for Equation (2) is N²+N/2.

The Equations (1) and (2) can be applied to the two-layer and four-layer cases as well with the following definitions. For the two-layer case in which the per-layer EIS is measured for a first layer transmitted from a first TRP at AOA1 and a second layer is transmitted from a second TRP at AOA2, let

$${EIS}_{S}^{1} ( ( {ϕ}_{1} , {θ}_{1} ) , ( {ϕ}_{2} , {θ}_{2} ) )$$

$${EIS}_{S}^{2} ( ( {ϕ}_{1} , {θ}_{1} ) , ( {ϕ}_{2} , {θ}_{2} ) )$$

denote the EIS in directions (φ₁, θ₁) and (φ₂, θ₂), respectively. Furthermore, define the sets

$${A}_{S}^{2 L , sep} ( α ) = \{ \begin{matrix}( {ϕ}_{1} , {θ}_{1} ) , ( {ϕ}_{2} , {θ}_{2} ) : {EIS}_{S}^{1} ( ( {ϕ}_{1} , {θ}_{1} ) , ( {ϕ}_{2} , {θ}_{2} ) ) \leq α \\ and {EIS}_{S}^{2} ( ( {ϕ}_{1} , {θ}_{1} ) , ( {ϕ}_{2} , {θ}_{2} ) ) \leq α\end{matrix} \}$$

$$and$$

$${A}_{S}^{2 L , sum} ( α ) = \{ ( {ϕ}_{1} , {θ}_{1} ) , ( {ϕ}_{2} , {θ}_{2} ) : {EIS}_{S}^{1} ( ( {ϕ}_{1} , {θ}_{1} ) , ( {ϕ}_{2} , {θ}_{2} ) ) + {EIS}_{S}^{2} ( ( {ϕ}_{1} , {θ}_{1} ) , ( {ϕ}_{2} , {θ}_{2} ) ) \leq α \} ,$$

which apply to

$${EIS}_{S}^{1}$$

((φ₁, θ₁), (φ₂, θ₂)) and to

$${EIS}_{S}^{2}$$

((φ₁, θ₁), (φ₂, θ₂)) individually and to their sum, respectively. Finally, based on these two sets, define the indicator functions

$${I}_{{A}_{S}^{2 L , sep}} ( {ϕ}_{i} , {θ}_{i} , {ϕ}_{j} , {θ}_{j} ) = \{ \begin{matrix}1 & ( {ϕ}_{i} , {θ}_{i} , {ϕ}_{j} , {θ}_{j} ) ∈ {A}_{S}^{2 L , sep} \\ 0 & else\end{matrix}$$

$$and$$

$${I}_{{A}_{S}^{2 L , sum}} ( {ϕ}_{i} , {θ}_{i} , {ϕ}_{j} , {θ}_{j} ) = \{ \begin{matrix}1 & ( {ϕ}_{i} , {θ}_{i} , {ϕ}_{j} , {θ}_{j} ) ∈ {A}_{S}^{2 L , sum} \\ 0 & else\end{matrix} .$$

The complementary cumulative distribution function of coverage for a first layer transmitted from a first TRP at AOA1 and a second layer transmitted from a second TRP at AOA2 can be evaluated by using these two indicator functions in the Equations (1) and (2). The indicator function

$${I}_{{A}_{S}^{2 L , sep}}$$

(φᵢ, θᵢ, φⱼ, θⱼ) is used to define

$${CCDF}_{S}^{2 L , sep}$$

of EIS for the layers separately, and the indicator function

$${I}_{{A}_{S}^{2 L , sum}}$$

(φᵢ, θᵢ, φⱼ, θⱼ) is used to define

$${CCDF}_{S}^{2 L , sum}$$

for the sum EIS. The complementary cumulative distribution function for four-layer transmission can be defined in a similar way.

It should be noted that all of the EIS values discussed above depend on whether one or two downlink control information (DCI) transmission are used for the transmission of the multiple layers. With a single DCI, the layers can be demodulated and decoded jointly. Conversely, with two DCIs, it can be assumed that the layers are demodulated and decoded independently.

There is an issue with the complementary cumulative distribution function definitions in the Equations (1) and (2) in that the number of required measurements is approximately N²/2 and this number of measurements is not feasible due to the difficulty of the test environment as well as the time required. Thus, the following possibilities are considered for reducing this complexity.

First, consider the case that the single Rx chain EIS spherical coverage measurements are taken prior to the multiple Rx chain measurements so that the values

$$\{ EIS ( {ϕ}_{i} , {θ}_{i} ) : 1 \leq i \leq N \}$$

are known. Furthermore, consider the case that the purpose of the measurement is not to evaluate complementary cumulative distribution of the multi-Rx EIS. Instead, consider the case that the purpose of the measurement is to determine if the spherical coverage requirement is met.

Assume that the multi-Rx multi-DL spherical coverage requirement has been defined as

$${CCDF}_{S} ( {α}_{0} ) \leq {p}_{0} .$$

When verifying the multi-Rx spherical coverage requirement, it is not necessary to take measurements for a pair of angles (φᵢ, θᵢ) and (φⱼ, θⱼ) unless both

$$EIS ( {ϕ}_{i} , {θ}_{i} ) \leq {α}_{0} and EIS ( {ϕ}_{j} , {θ}_{j} ) \leq {α}_{0} .$$

Let p₁ be chosen from the single Rx complementary cumulative distribution function so that:

$$CCDF ( {α}_{0} ) \leq {p}_{1} .$$

It then follows that that only p₁N angles satisfy the requirement that:

$$EIS ( {ϕ}_{i} , {θ}_{i} ) \leq {α}_{0}$$

and there are only

$${p}_{1}^{2} {N}^{2}$$

pans of the angles with the property that:

$$EIS ( {ϕ}_{i} , {θ}_{i} ) \leq {α}_{0} and EIS ( {ϕ}_{j} , {θ}_{j} ) \leq {α}_{0} .$$

If p₁ corresponds to the 50% percentile of the single Rx cumulative distribution function, then there are only N²/4 pairs of angles to consider, and by symmetry the number of measurements needed to verify the multi-Rx multi-DL performance as in the Equations (1) and (2) is only N²/8.

Accordingly, let p₁ be chosen from the single Rx complementary cumulative distribution function such that:

$$CCDF ( {α}_{0} ) \leq {p}_{1} .$$

If pairs ((φᵢ, θᵢ), (φⱼ, θⱼ)) are limited to the set for which

$$EIS ( {ϕ}_{i} , {θ}_{i} ) \leq {α}_{0} and EIS ( {ϕ}_{j} , {θ}_{j} ) \leq {α}_{0}$$

then it is observed that the number of measurements required to measure multi-Rx spherical coverage as in Equations (1) and (2) is

$${p}_{1}^{2} {N}^{2} / 2 .$$

If p₁=0.5, then the required number of measurements is N²/8.

If known to the test equipment, hardware limitations may further limit the number pairs of angles ((φᵢ, θᵢ), (φⱼ, θⱼ)) for which EIS measurements are required. As an example, consider the case of a UE having two antenna panels with non-overlapping coverage. Further assume that the single Rx EIS requirement do corresponds to the 50% coverage threshold so that

$$CCDF ( {α}_{0} ) \leq 0.5 ,$$

and that each panel is responsible for half of this coverage. Thus, the coverage region of each panel is 25% of the unit sphere.

Now consider the case that there is only a single RF chain and baseband processor per panel so that each panel can only receive from a single AOA at a time. In some cases, the combination of an RF chain, a baseband processor and a set of antennas may be referred to as an antenna module. It will be assumed that an antenna module can only receive from a single AOA at a time, and as a result, in order to receive from two AOA's simultaneously, two antenna modules are required.

For the example above in which each panel covers 25% of the unit sphere and each panel has only a single antenna module, it is apparent that multi-Rx EIS measurement is only required for an antenna pair ((φᵢ, θᵢ), (φⱼ, θⱼ)) if the angle (φᵢ, θᵢ) is covered by the first panel and the angle (φⱼ, θⱼ) is covered by the second panel. Since each panel covers 25% of the unit sphere, there are only N²/16 pairs of angles ((φᵢ, θᵢ), (φⱼ, θⱼ) for which the simultaneous measurement is required. If the following two sets are defined:

$${I}_{1} = \{ i : 1 \leq i \leq N such that ( {ϕ}_{i} , {θ}_{i} ) is covered by panel 1 \} ,$$

$${I}_{2} = \{ i : 1 \leq i \leq N such that ( {ϕ}_{i} , {θ}_{i} ) is covered by panel 2 \} ,$$

then the spherical coverage can be computed as:

$$CCDF ( α ) = 1 - \frac{1}{8 {π}^{2}} {\sum }_{i ϵ {I}_{1}} {\sum }_{j ϵ {I}_{2}} {J}_{{A}_{S} ( α )} ( {ϕ}_{i} , {θ}_{i} , {ϕ}_{j} , {θ}_{j} ) W ( {ϕ}_{i} , {θ}_{i} ) W ( {ϕ}_{j} , {θ}_{j} ) .$$

Accordingly, it is observed that hardware limitations, if known, can greatly reduce the number of pairs of angles ((φᵢ, θᵢ), (φⱼ, θⱼ)) for which multi-Rx EIS measurements are required.

An additional issue to consider is that there may be significant overlap of the coverage of the antenna panels. In this case, for a single AOA, the UE can choose which antenna module to use when receiving the signal from a particular AOA. Thus, if two AOA's both fall within the coverage of a single panel, it may be possible to receive from both AOA's simultaneously if one of these two AOA's is covered by a second panel.

To reduce test time for multi-Rx multi-DL reception, it is very beneficial if the test equipment has knowledge of the hardware limitations of the device under test. As a result, it is beneficial for the UE to report, and the test equipment be able to extract, the following information when performing single Rx measurements on the device: 1) For each AOA, the number of antenna modules that can be used to receive the test signal; 2) For each AOA, the identities of the antenna module that can be used to receive the test signal; and 3) For each AOA, the EIS for each antenna module that can be used to receive the test signal.

With this information, the test equipment can determine whether it is necessary to take multi-Rx measurements for a pair of angles ((φᵢ, θⱼ), (φⱼ, θⱼ)) when evaluating spherical coverage, or if measurement is not necessary because either: A) the same antenna module is used for both angles, or B) a second antenna module is available for one of the angles, but the EIS is above a threshold.

Accordingly, to reduce the complexity of the spherical coverage evaluation, the UE assigns numbers to identify each of the antenna modules in the UE and reports the identity of the antenna module used when EIS is measured during single-Rx single-AOA measurements.

Moreover, during single-Rx single-AOA measurements, the EIS is measured for each of the antenna modules capable of receiving the signal from a particular AOA.

Regarding the granularity of measurement, a final alternative for reducing complexity for multi-Rx measurement is to reduce the granularity of the AOA grid from that used for single-Rx measurements. This may result in a significant reduction in measurement time with only a slight loss of accuracy.

For example, assume that a grid of N=100 angles (φᵢ, θᵢ) are used when measuring the single-Rx EIS complementary cumulative distribution function. When performing the measurements needed to evaluate the multi-Rx EIS cumulative distribution function, the test equipment could subsample the grid of N=100 angles by one-half to get a set of N₁=50 angles. With this reduction, the total number of angle pairs ((φᵢ, θᵢ), (φⱼ, θⱼ)) is reduced by a factor of 4 from 10,000 to 2500.

In some cases, the number of points N₁ may be successively refined depending on the result of the test. For example, if the test passes with N₁=50, then the test may be stopped. Conversely, if the test fails for N₁=50, then N₁ may be increased to N₁=60 by adding 10 angles from the original set of to the set of N=100 angles for which measurements have already been performed (so that the existing 2500 measurements can be reused). If the test passes with N₁=60, then the test is stopped. Conversely, if the test fails with N₁=60, then the measurement grid is refined by adding more angles.

It should be noted that this method of reducing complexity by reducing the granularity of the measurement grid can be combined with any of the other methods for complexity reduction.

Consequently, the multi-TRP reception testing is a two-step process. In the first step, the test equipment performs multiple single probe (i.e., single Rx chain) EIS spherical coverage measurements first determine if it is possible for the UE to simultaneously receive independent signaling from two different directions. The second step is to actually test the candidate combination. The reason that the candidate combination must be tested is that the signals may interfere (first signal interferes with second panel, second signal interferes with first panel).

The test equipment sets the AOA (according to its configuration) and the power level. The UE does not know the power level used to transmit by the test equipment and it does not know the test equipment AOA definition. In some embodiments, the UE only reports the antenna modules for which a signal is successfully received. The test equipment records the AOA and the power level. The test equipment can determine the range of AOA values from its measurements.

To reduce the complexity of determining the spherical coverage with simultaneous reception of independent signals from at least two different AoA values, the test equipment reduces the number of candidate combinations in accordance with the above aspects.

In one embodiment, the UE may further enhance the reporting (e.g., during the first step) by determining a UE-defined AoA value (i.e., defined internally to the UE) for a received test signal and reporting the same, i.e., in addition to the antenna module IDs for which the test signal is successfully received. In another embodiment, the UE may further enhance the reporting (e.g., during the first step) by determining a UE-defined EIS value (i.e., defined internally to the UE) for a received test signal and reporting the same, i.e., in addition to the antenna module IDs for which the test signal is successfully received.

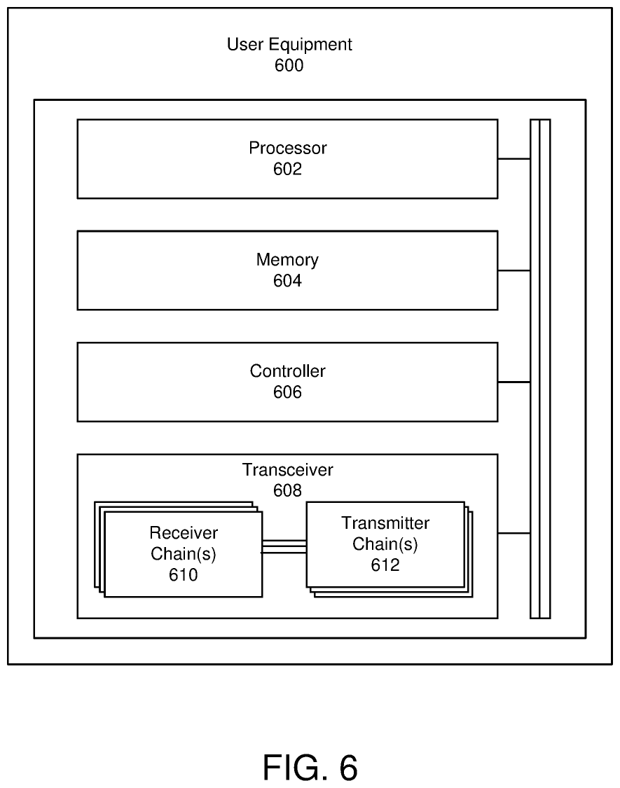

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, a Field Programable Gate Array (FPGA), or any combination thereof). In some implementations, the processor 602 may be configured to operate the memory 604. In some other implementations, the memory 604 may be integrated into the processor 602.

The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the UE functions described herein (e.g., executing, by the processor 602, instructions stored in the memory 604). For example, the processor 602 may support wireless communication at the UE 600 in accordance with examples as disclosed herein. The UE 600 may be configured to support a means for identifying a set of antenna modules of the UE 600.

In some implementations, to identify the set of antenna modules, the UE 600 may be configured to label each antenna module in the set of antenna modules with a number from one to a total amount of antenna modules. For example, if the UE 600 had 8 antenna modules, each antenna module would be labeled with a (unique) number between 1 and 8. In some implementations, each antenna module comprises a single radio frequency (RF) chain and a single baseband processor.

The UE 600 may be configured to support a means for receiving a first plurality of signals (i.e., test signals transmitted by one or more probes/TRPs of the testing equipment) via the set of antenna modules and determining a first plurality of measurement values based on the first plurality of signals. In such embodiments, the first plurality of measurement values may include a set of antenna module identifiers corresponding to a set of UE antenna modules at which one or more of the first plurality of signals are successfully demodulated.

The UE 600 may be further configured to support a means for reporting the first plurality of measurement values (i.e., transmitting a report containing the measurement values). In some implementations, to report the first plurality of measurement values, the UE 600 may be configured to indicate a set of antenna module identifiers for which one or more of the first plurality of signals are successfully demodulated. For example, for a respective signal of the first plurality of signals, the UE may report the antenna module IDs for which the respective signal is successfully demodulated.

In one embodiment, the UE 600 may additionally estimate a respective AoA measurement (i.e., defined internally to the UE) associated with a respective signal of the first plurality of signals, where the AoA measurement is relative to the receiving antenna module of the set of antenna modules. In such embodiments, the UE 600 may report one or more respective AoA measurements when reporting the set of antenna module identifiers for which one or more of the first plurality of signals are successfully demodulated. In another embodiment, the UE 600 may additionally estimate a respective EIS measurement (i.e., defined internally to the UE) associated with a respective signal of the first plurality of signals, where the EIS measurement is relative to the receiving antenna module of the set of antenna modules. In such embodiments, the UE 600 may report one or more respective EIS measurements when reporting the set of antenna module identifiers for which one or more of the first plurality of signals are successfully demodulated.

The UE 600 may be configured to support a means for receiving a second plurality of signals using a plurality of pairs of antenna modules and a means for reporting a second plurality of measurement values based on the second plurality of signals. In some implementations, the second plurality of measurement values comprises a set of per-layer EIS values.

The controller 606 may manage input and output signals for the UE 600. The controller 606 may also manage peripherals not integrated into the UE 600. In some implementations, the controller 606 may utilize an operating system (OS) such as iOS®, ANDROID®, WINDOWS®, or other operating systems (OSes). In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the receiving signal and obtain the transmitted data by reversing the modulation technique applied during transmission of the signal. The receiver chain 610 may include at least one decoder for decoding and processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

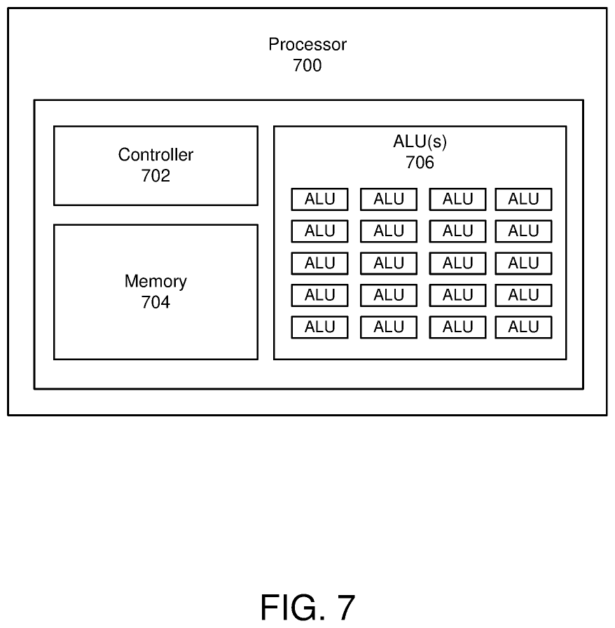

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. For example, the processor 700 may perform one or more of the testing equipment functions described herein. The processor 700 may be configured to or operable to support a means for transmitting a first plurality of signals (i.e., test signals). In various embodiments, the processor 700 transmits the first plurality of signals using a plurality of test probes or TRPs. In some embodiments, the first plurality of signals is associated with a set of AoA values.

The processor 700 may be configured to support a means for receiving, from a UE, a first plurality of measurement values comprising a set of antenna module IDs for which one or more of the first plurality of signals are successfully demodulated.

In some implementations, the processor 700 may be configured to determine a set of EIS values associated with the set of antenna module IDs, where the set of EIS values is based at least in part on the first plurality of signals and the first plurality of measurement values, and where each EIS value corresponds to at least two AoA values.

The processor 700 may be configured to support a means for determining a set of antenna tuples for multi-layer reception based on the first plurality of measurement values. In some embodiments, each antenna tuple of the set of antenna tuples for multi-layer reception includes at least two antenna modules (e.g., a pair of antenna modules) and a subset of AoA values that the pair of antenna modules is capable of receiving.

In some implementations, to determine the set of antenna tuples for multi-layer reception, the processor 700 may be configured to determine, based on the set of AoA values, whether a respective pair of antenna modules can receive a set of signals from a respective pair of TRPs. If the processor 700 determines that the respective pair of antenna modules can receive the set of signals, then that respective pair of antenna modules is included in the set of antenna tuples. Otherwise, if the processor 700 determines that the respective pair of antenna modules cannot receive the set of signals, then the processor 700 disregards the respective pair of antenna modules and that respective pair of antennas is not included in the set of antenna tuples.

In certain implementations, to determine whether the respective pair of antenna modules can receive a set of signals from the respective pair of TRPs, the processor 700 may be configured to: A) select a first AoA value and a second AoA value from the set of AoA values; B) identify a first EIS value associated with a first antenna module and corresponding to the first AoA value and the second AoA value; C) identify a second EIS value associated with a second antenna module and corresponding to the first AoA value and the second AoA value; and D) determine that the respective pair of antenna modules can receive the set of signals in response to both the first EIS value and the second EIS value satisfying a threshold value.

In certain embodiments, the respective pair of antenna modules comprises a first antenna module and a second antenna module having non-overlapping coverage. In such embodiments, to determine whether the respective pair of antenna modules can receive a set of signals from the respective pair of TRPs, the processor 700 may be configured to: A) select a first AoA value and a second AoA value from the set of AoA values; and B) determine that the respective pair of antenna modules can receive the set of signals in response to the first AoA value being within a first coverage associated with the first antenna module and the second AoA value being within a second coverage associated with the second antenna module.

The processor 700 may be configured to support a means for transmitting a second plurality of signals based on the set of antenna tuples. In some implementations, to transmit the second plurality of signals, the processor 700 may be configured to perform simultaneous transmission of a plurality of transmission layers via at least two TRPs.

The processor 700 may be configured to support a means for receiving a second plurality of measurement values. In some implementations, the processor 700 may be configured to determine a set of per-layer EIS values based at least in part on the second plurality of signals and the second plurality of measurement values.

The processor 700 may be configured to support a means for determining a spherical coverage of the UE for simultaneous reception. In some implementations, to determine the spherical coverage of the UE, the processor 700 may be configured to define a CCDF based at least in part on a combination of EIS values. In various embodiments, the processor 700 may be configured to determine whether the UE satisfies a spherical coverage requirement based on the CCDF.

In some implementations, the processor 700 may perform one or more of the UE functions described herein. The processor 700 may be configured to or operable to support a means for identifying a set of antenna modules of a UE.

In some implementations, to identify the set of antenna modules, the processor 700 may be configured to label each antenna module in the set of antenna modules with a number from one to a total amount of antenna modules. For example, if the processor 700 had 8 antenna modules, each antenna module would be labeled with a (unique) number between 1 and 8. In some implementations, each antenna module comprises a single radio frequency (RF) chain and a single baseband processor.

The processor 700 may be configured to support a means for receiving a first plurality of signals (i.e., test signals transmitted by one or more probes/TRPs of the testing equipment) via the set of antenna modules and determining a first plurality of measurement values based on the first plurality of signals. In such embodiments, the first plurality of measurement values may include a set of antenna module identifiers for which one or more of the first plurality of signals are successfully demodulated.

The processor 700 may be further configured to support a means for reporting the first plurality of measurement values (i.e., transmitting a report containing the measurement values). In some implementations, to report the first plurality of measurement values, the processor 700 may be configured to indicate a set of antenna module identifiers for which one or more of the first plurality of signals are successfully demodulated. For example, for a respective signal of the first plurality of signals, the UE may report the antenna module IDs for which the respective signal is successfully demodulated.

In one embodiment, the processor 700 may additionally estimate a respective AoA measurement (i.e., defined internally to the UE) associated with a respective signal of the first plurality of signals, where the AoA measurement is relative to the receiving antenna module of the set of antenna modules. In such embodiments, the processor 700 may report one or more respective AoA measurements when reporting the set of antenna module identifiers for which one or more of the first plurality of signals are successfully demodulated. In another embodiment, the processor 700 may additionally estimate a respective EIS measurement (i.e., defined internally to the UE) associated with a respective signal of the first plurality of signals, where the EIS measurement is relative to the receiving antenna module of the set of antenna modules. In such embodiments, the processor 700 may report one or more respective EIS measurements when reporting the set of antenna module identifiers for which one or more of the first plurality of signals are successfully demodulated.

The processor 700 may be configured to support a means for receiving a second plurality of signals using a plurality of pairs of antenna modules and a means for reporting a second plurality of measurement values based on the second plurality of signals. In some implementations, the second plurality of measurement values comprises a set of per-layer EIS values.

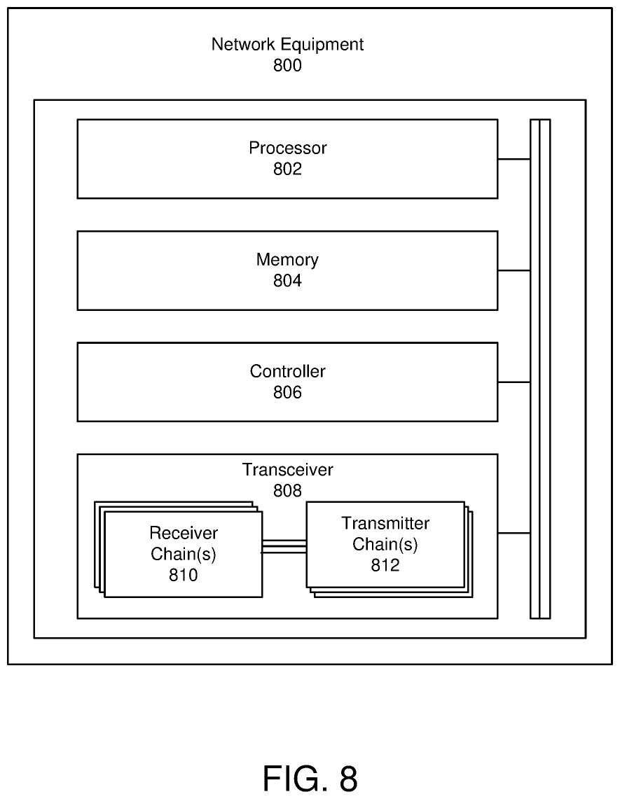

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804).

For example, the processor 802 may support wireless communication at the NE 800 in accordance with examples as disclosed herein. The NE 800 may be configured to support a means for transmitting a first plurality of signals (i.e., test signals). In various embodiments, the NE 800 transmits the first plurality of signals using a plurality of test probes or TRPs. In some embodiments, the first plurality of signals is associated with a set of AoA values.

The NE 800 may be configured to support a means for receiving, from a UE, a first plurality of measurement values comprising a set of antenna module IDs for which one or more of the first plurality of signals are successfully demodulated.

In some implementations, the NE 800 may be configured to determine a set of EIS values associated with the set of antenna module IDs, where the set of EIS values is based at least in part on the first plurality of signals and the first plurality of measurement values, and where each EIS value corresponds to at least two AoA values.

The NE 800 may be configured to support a means for determining a set of antenna tuples for multi-layer reception based on the first plurality of measurement values. In some embodiments, each antenna tuple of the set of antenna tuples for multi-layer reception includes at least two antenna modules (e.g., a pair of antenna modules) and a subset of AoA values that the pair of antenna modules is capable of receiving.

In some implementations, to determine the set of antenna tuples for multi-layer reception, the NE 800 may be configured to determine, based on the set of AoA values, whether a respective pair of antenna modules can receive a set of signals from a respective pair of TRPs. If the NE 800 determines that the respective pair of antenna modules can receive the set of signals, then that respective pair of antenna modules is included in the set of antenna tuples. Otherwise, if the NE 800 determines that the respective pair of antenna modules cannot receive the set of signals, then the NE 800 disregards the respective pair of antenna modules and that respective pair of antennas is not included in the set of antenna tuples.

In certain implementations, to determine whether the respective pair of antenna modules can receive a set of signals from the respective pair of TRPs, the NE 800 may be configured to: A) select a first AoA value and a second AoA value from the set of AoA values; B) identify a first EIS value associated with a first antenna module and corresponding to the first AoA value and the second AoA value; C) identify a second EIS value associated with a second antenna module and corresponding to the first AoA value and the second AoA value; and D) determine that the respective pair of antenna modules can receive the set of signals in response to both the first EIS value and the second EIS value satisfying a threshold value.

In certain embodiments, the respective pair of antenna modules comprises a first antenna module and a second antenna module having non-overlapping coverage. In such embodiments, to determine whether the respective pair of antenna modules can receive a set of signals from the respective pair of TRPs, the NE 800 may be configured to: A) select a first AoA value and a second AoA value from the set of AoA values; and B) determine that the respective pair of antenna modules can receive the set of signals in response to the first AoA value being within a first coverage associated with the first antenna module and the second AoA value being within a second coverage associated with the second antenna module.

The NE 800 may be configured to support a means for transmitting a second plurality of signals based on the set of antenna tuples. In some implementations, to transmit the second plurality of signals, the NE 800 may be configured to perform simultaneous transmission of a plurality of transmission layers via at least two TRPs.

The NE 800 may be configured to support a means for receiving a second plurality of measurement values. In some implementations, the NE 800 may be configured to determine a set of per-layer EIS values based at least in part on the second plurality of signals and the second plurality of measurement values.

The NE 800 may be configured to support a means for determining a spherical coverage of the UE for simultaneous reception. In some implementations, to determine the spherical coverage of the UE, the NE 800 may be configured to define a CCDF based at least in part on a combination of EIS values. In various embodiments, the NE 800 may be configured to determine whether the UE satisfies a spherical coverage requirement based on the CCDF.

The controller 806 may manage input and output signals for the NE 800. The controller 806 may also manage peripherals not integrated into the NE 800. In some implementations, the controller 806 may utilize an OS such as iOS®, ANDROID®, WINDOWS®, or other OSes. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the receiving signal and obtain the transmitted data by reversing the modulation technique applied during transmission of the signal. The receiver chain 810 may include at least one decoder for decoding and processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

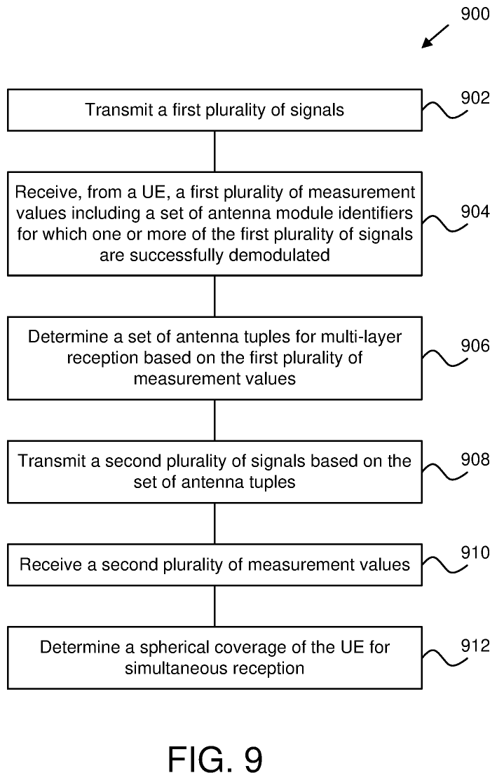

FIG. 9 illustrates a flowchart of a method 900 in accordance with aspects of the present disclosure. The operations of the method 900 may be implemented by a test equipment as described herein. In some implementations, the test equipment may execute a set of instructions to control the function elements of the test equipment to perform the described functions.

At Step 902, the method 900 may include transmitting a first plurality of signals (i.e., test signals). The operations of Step 902 may be performed in accordance with examples as described herein. In some implementations, aspects of the operations of Step 902 may be performed by a NE as described with reference to FIG. 8.

At Step 904, the method 900 may include receiving, from a UE, a first plurality of measurement values including a set of antenna module identifiers for which one or more of the first plurality of signals are successfully demodulated. The operations of Step 904 may be performed in accordance with examples as described herein. In some implementations, aspects of the operations of Step 904 may be performed by a NE as described with reference to FIG. 8.

At Step 906, the method 900 may include determining a set of antenna tuples for multi-layer reception based on the first plurality of measurement values. The operations of Step 906 may be performed in accordance with examples as described herein. In some implementations, aspects of the operations of Step 906 may be performed a NE as described with reference to FIG. 8.

At Step 908, the method 900 may include transmitting a second plurality of signals (i.e., test signals) based on the set of antenna tuples. The operations of Step 908 may be performed in accordance with examples as described herein. In some implementations, aspects of the operations of Step 908 may be performed by a NE as described with reference to FIG. 8.

At Step 910, the method 900 may include receiving a second plurality of measurement values. The operations of Step 910 may be performed in accordance with examples as described herein. In some implementations, aspects of the operations of Step 910 may be performed by a NE as described with reference to FIG. 8.

At Step 912, the method 900 may include determining a spherical coverage of the UE for simultaneous reception. The operations of Step 912 may be performed in accordance with examples as described herein. In some implementations, aspects of the operations of Step 912 may be performed a NE as described with reference to FIG. 8.

It should be noted that the method 900 described herein describes one possible implementation, and that the operations and the steps may be rearranged or otherwise modified and that other implementations are possible.

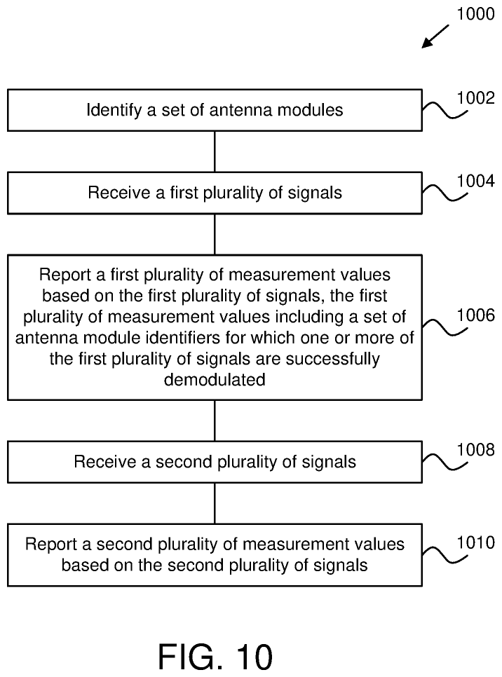

FIG. 10 illustrates a flowchart of a method 1000 in accordance with aspects of the present disclosure. The operations of the method 1000 may be implemented by a UE as described herein. In some implementations, the UE may execute a set of instructions to control the function elements of the UE to perform the described functions.

At Step 1002, the method 1000 may include identifying a set of antenna modules corresponding to the UE. The operations of Step 1002 may be performed in accordance with examples as described herein. In some implementations, aspects of the operations of Step 1002 may be performed by a UE as described with reference to FIG. 6.

At Step 1004, the method 1000 may include receiving a first plurality of signals (i.e., test signals). The operations of Step 1004 may be performed in accordance with examples as described herein. In some implementations, aspects of the operations of Step 1004 may be performed by a UE as described with reference to FIG. 6.

At Step 1006, the method 1000 may include report a first plurality of measurement values based on the first plurality of signals, wherein the first plurality of measurement values includes a set of antenna module identifiers for which one or more of the first plurality of signals are successfully demodulated. The operations of Step 1006 may be performed in accordance with examples as described herein. In some implementations, aspects of the operations of Step 1006 may be performed a UE as described with reference to FIG. 6.

At Step 1008, the method 1000 may include receiving a second plurality of signals (i.e., test signals) using a plurality of pairs of antenna modules. The operations of Step 1008 may be performed in accordance with examples as described herein. In some implementations, aspects of the operations of Step 1008 may be performed by a UE as described with reference to FIG. 6.

At Step 1010, the method 1000 may include reporting a second plurality of measurement values based on the second plurality of signals. The operations of Step 1010 may be performed in accordance with examples as described herein. In some implementations, aspects of the operations of Step 1010 may be performed a UE as described with reference to FIG. 6.

It should be noted that the method 1000 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A test equipment for wireless communication, comprising:
at least one memory; and
at least one processor coupled with the at least one memory and configured to cause the test equipment to:
transmit a first plurality of signals;
receive, from a user equipment (UE), a first plurality of measurement values comprising a set of antenna module identifiers for which one or more of the first plurality of signals are successfully demodulated;
determine a set of antenna tuples for multi-layer reception based on the first plurality of measurement values;
transmit a second plurality of signals based on the set of antenna tuples;
receive a second plurality of measurement values; and
determine a spherical coverage of the UE for simultaneous reception.

2. The test equipment of claim 1, wherein the first plurality of signals is associated with a set of angle-of-arrival (AoA) values, and wherein to determine the set of antenna tuples for multi-layer reception, the at least one processor is configured to cause the test equipment to:
determine, based on the set of AoA values, whether a respective pair of antenna modules can receive a set of signals from a respective pair of transmission-reception points (TRPs);
include the respective pair of antenna modules in the set of antenna tuples in response to a determination that the respective pair of antenna modules can receive the set of signals; and
disregard the respective pair of antenna modules in response to a determination that the respective pair of antenna modules cannot receive the set of signals.

3. The test equipment of claim 2, wherein to determine whether the respective pair of antenna modules can receive a set of signals from the respective pair of TRPs, the at least one processor is configured to cause the test equipment to:
select a first AoA value and a second AoA value from the set of AoA values;
identify a first effective isotropic sensitivity (EIS) value associated with a first antenna module and corresponding to the first AoA value and the second AoA value;
identify a second EIS value associated with a second antenna module and corresponding to the first AoA value and the second AoA value; and
determine that the respective pair of antenna modules can receive the set of signals in response to both the first EIS value and the second EIS value satisfying a threshold value.

4. The test equipment of claim 2, wherein the respective pair of antenna modules comprises a first antenna module and a second antenna module having non-overlapping coverage, and wherein to determine whether the respective pair of antenna modules can receive a set of signals from the respective pair of TRPs, the at least one processor is configured to cause the test equipment to:
select a first AoA value and a second AoA value from the set of AoA values; and
determine that the respective pair of antenna modules can receive the set of signals in response to the first AoA value being within a first coverage associated with the first antenna module and the second AoA value being within a second coverage associated with the second antenna module.

5. The test equipment of claim 1, wherein to transmit the first plurality of signals, the at least one processor is configured to cause the test equipment to transmit a signal from at least two transmission-reception points (TRPs), wherein the at least one processor is configured to cause the test equipment to determine a set of effective isotropic sensitivity (EIS) values associated with the set of antenna module identifiers, wherein the set of EIS values is based at least in part on the first plurality of signals and the first plurality of measurement values, and wherein each EIS value corresponds to at least two angle-of-arrival (AoA) values.

6. The test equipment of claim 5, wherein to transmit the second plurality of signals, the at least one processor is configured to cause the test equipment to perform simultaneous transmission of a plurality of transmission layers via at least two TRPs, and wherein the at least one processor is configured to cause the test equipment to determine a set of per-layer EIS values based at least in part on the second plurality of signals and the second plurality of measurement values.

7. The test equipment of claim 6, wherein to determine the spherical coverage of the UE, the at least one processor is configured to cause the test equipment to define a complementary cumulative distribution function (CCDF) based at least in part on a combination of EIS values.

8. The test equipment of claim 7, wherein the at least one processor is configured to cause the test equipment to determine whether the UE satisfies a spherical coverage requirement based on the CCDF.

9. A method performed by a test equipment, the method comprising:
transmitting a first plurality of signals;
receiving, from a user equipment (UE), a first plurality of measurement values comprising a set of antenna module identifiers for which one or more of the first plurality of signals are successfully demodulated;
determining a set of antenna tuples for multi-layer reception based on the first plurality of measurement values;
transmitting a second plurality of signals based on the set of antenna tuples;
receiving a second plurality of measurement values; and
determining a spherical coverage of the UE for simultaneous reception.

10. The method of claim 9, wherein the first plurality of signals is associated with a set of angle-of-arrival (AoA) values, and wherein determining the set of antenna tuples for multi-layer reception comprises:
determining, based on the set of AoA values, whether a respective pair of antenna modules can receive a set of signals from a respective pair of transmission-reception points (TRPs);
including the respective pair of antenna modules in the set of antenna tuples in response to a determination that the respective pair of antenna modules can receive the set of signals; and
disregarding the respective pair of antenna modules in response to a determination that the respective pair of antenna modules cannot receive the set of signals.

11. The method of claim 9, wherein transmitting the first plurality of signals comprises transmitting a signal from at least two transmission-reception points (TRPs), wherein the method further comprises determining a set of effective isotropic sensitivity (EIS) values associated with the set of antenna module identifiers, wherein the set of EIS values is based at least in part on the first plurality of signals and the first plurality of measurement values, and wherein each EIS value corresponds to at least two angle-of-arrival (AoA) values.

12. A user equipment (UE) for wireless communication, comprising:
at least one memory; and
at least one processor coupled with the at least one memory and configured to cause the UE to:
identify a set of antenna modules corresponding to a receiver of the UE;
receive a first plurality of signals;
report a first plurality of measurement values based on the first plurality of signals, wherein the first plurality of measurement values comprise a set of antenna module identifiers for which one or more of the first plurality of signals are successfully demodulated;
receive a second plurality of signals using a plurality of pairs of antenna modules; and
report a second plurality of measurement values based on the second plurality of signals.

13. The UE of claim 12, wherein to identify the set of antenna modules, the at least one processor is configured to label each antenna module in the set of antenna modules with a number from one to a total amount of antenna modules.

14. The UE of claim 12, wherein the at least one processor is configured to cause the UE to determine a respective angle-of-arrival (AoA) measurement associated with a respective signal of the first plurality of signals, the AoA measurement relative to a receiving antenna module of the set of antenna modules, and wherein the first plurality of measurement values comprises the respective AoA measurement.

15. The UE of claim 12, wherein the at least one processor is configured to cause the UE to determine a respective effective isotropic sensitivity (EIS) measurement associated with a respective signal of the first plurality of signals, the EIS measurement relative to a receiving antenna module of the set of antenna modules, and wherein the first plurality of measurement values comprises the respective EIS measurement.

16. The UE of claim 12, wherein each antenna module comprises a single radio frequency (RF) chain and a single baseband processor.

17. A processor for wireless communication, comprising:
at least one controller coupled with at least one memory and configured to cause the processor to:
identify a set of antenna modules corresponding to a user equipment (UE);
receive a first plurality of signals;
report a first plurality of measurement values based on the first plurality of signals, wherein the first plurality of measurement values comprise a set of antenna module identifiers for which one or more of the first plurality of signals are successfully demodulated;
receive a second plurality of signals using a plurality of pairs of antenna modules; and
report a second plurality of measurement values based on the second plurality of signals.

18. The processor of claim 17, wherein to identify the set of antenna modules, the at least one controller is configured to label each antenna module in the set of antenna modules with a number from one to a total amount of antenna modules.

19. The processor of claim 17, wherein the at least one controller is configured to cause the processor to determine a respective angle-of-arrival (AoA) measurement associated with a respective signal of the first plurality of signals, the AoA measurement relative to a receiving antenna module of the set of antenna modules, and wherein the first plurality of measurement values comprises the respective AoA measurement.

20. The processor of claim 17, wherein the at least one processor is configured to cause the UE to determine a respective effective isotropic sensitivity (EIS) measurement associated with a respective signal of the first plurality of signals, the EIS measurement relative to a receiving antenna module of the set of antenna modules, and wherein the first plurality of measurement values comprises the respective EIS measurement.
